(19) United States
(12) Patent Application Publication
(10) Pub. No.: US 2018/0116199 A1
(43) Pub. Date: May 3, 2018

(54) MOSQUITO KILLING METHOD AND APPARATUS

(71) Applicants: Robert Louis Hartman, Warren, NJ (US); Edward Hartman, Menlo Park, CA (US)

(72) Inventors: Robert Louis Hartman, Warren, NJ (US); Edward Hartman, Menlo Park, CA (US)

(21) Appl. No.: 15/790,492

(22) Filed: Oct. 23, 2017

Related U.S. Application Data
(63) Continuation-in-part of application No. 15/342,249, filed on Nov. 3, 2016, now abandoned.

(51) Int. Cl. A01M 1/22; A01M 1/02

(52) U.S. Cl. CPC A01M 1/226; A01K 29/005; A01M 1/026

(57) ABSTRACT

A broadcasting apparatus is provided for killing insects. The broadcasting apparatus includes an emitter operable to emit a wave therefrom. The wave is at least one of a sound or one of a light. The apparatus includes a detection means of determining the species of insect, a processor and a memory to provide the most effective wave to kill the insect. A power source is operatively connected to the emitter and provides power to the emitter. The wave emitted from the emitter is capable of breaking a wing of an insect.

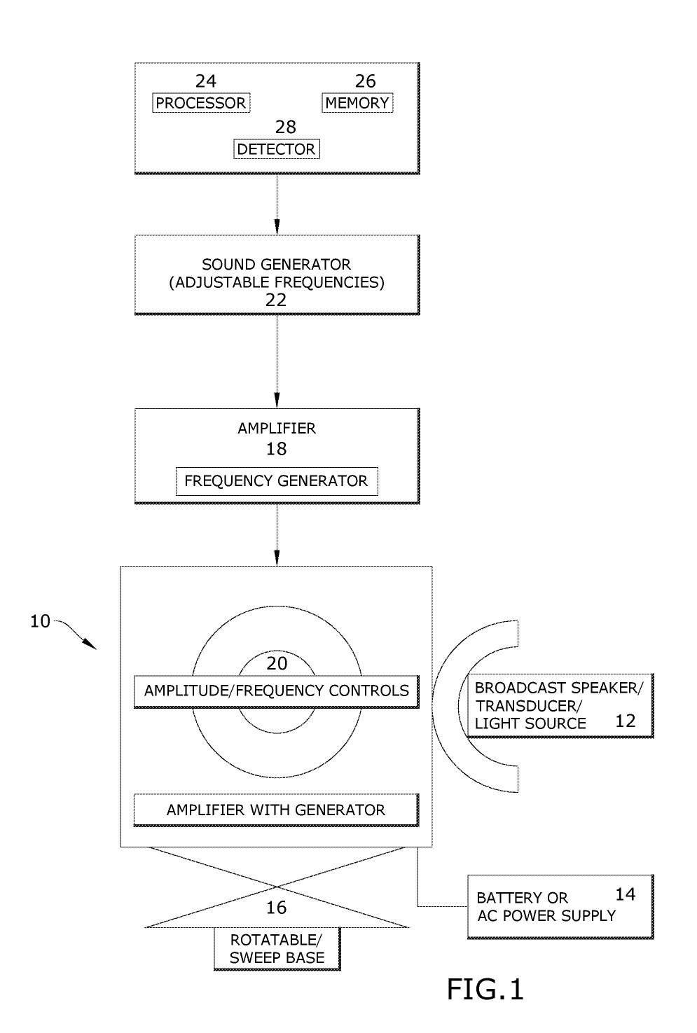

This application is a continuation in part of U.S. non-provisional application Ser. No. 15/342,249 filed on Nov. 3, 2016.

### BACKGROUND OF THE INVENTION

The present invention relates to killing insects and, more particularly, to a method and apparatus for producing a high frequency sound or light that destroys the wings of flying insects. The present invention further relates to determining a species of insect and determining a frequency to destroy the wings of the insects.

Mosquitoes are a family of small, midge-like flies. Although a few species are harmless or even useful to humanity, most are considered a nuisance because they use their salivation in the process of puncturing the skin of living mammals, including humans, to consume their blood, which causes itchy, oftentimes painful red bumps to appear. The females of many species of mosquitoes are blood-eating pests. In feeding on blood, some of them transmit extremely harmful human and livestock diseases, such as malaria, yellow fever, and filariasis.

Several methods have been implemented to kill mosquitoes. For example, an electrical apparatus kills mosquitoes with high-voltage and a sticky substrate may trap mosquitoes until they expire. The methods mentioned above depend upon the mosquitoes flying to the apparatus, either by scent, light attraction or accidentally venturing onto the device. None of these methods are particularly effective.

Other means attempt to repel the flying pests with ultrasonic sound bursts that claim to upset the insects' nervous system and cause the insects to avoid flying into the area. Alternatively, ultrasonic sound bursts are used to cause turbulence, which also deters insects from flying into the area. However, these methods do not kill the insects.

As can be seen, there is a need for a method of effectively killing mosquitoes and other flying insects.

### SUMMARY OF THE INVENTION

In one aspect of the present invention, a method of disabling flying insects comprises: determining a resonate frequency of a wing of an insect capable of breaking the wing of the insect; providing a broadcasting apparatus comprising an emitter operable to emit a wave comprising the resonate frequency of the wing of the insect, wherein the wave is at least one of a sound and a light; and emitting the wave comprising the resonate frequency of the wing of the insect from the broadcasting apparatus.

In another aspect of the present invention, the broadcasting apparatus comprises a processor, a memory and a detector operable to detect a type of species of the insect, wherein the memory stores data comprising a plurality of types of species of insects each linked with a unique destructive resonate frequency, wherein the processor determines the unique destructive resonate frequency of a detected insect using the detector and the data; and directs the emitter to emit the unique destructive resonate frequency.

These and other features, aspects and advantages of the present invention will become better understood with reference to the following drawings, description and claims.

### BRIEF DESCRIPTION OF THE DRAWINGS

The FIGURE is a schematic view of an embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes a method and apparatus for selectively killing flying insects, such as mosquitoes, by emitting high frequency sound or light waves. The present invention broadcasts sound waves at selected high-frequencies at a multiple of the base resonate frequency of the insects' wing. As the sound or light energy is absorbed into the wing, the wing is forced by resonance to bend in short spans and break. Broadcasting these selected sound or light waves destroys the insect's wings and hence causes the insect to starve to death.

The present invention emits a resonate frequency of a wing of an insect capable of breaking the wing of the insect, which may be referred to as a destructive resonate frequency. The destructive resonate frequency may be the base resonate frequency of the wing. A base frequency of a wing is the lowest frequency of vibration. For a winged insect, such as a mosquito, with the wing attached to the body at one end by muscles, the lowest frequency occurs along a smooth arc from the muscles to the tip of the wing while the wing is oscillating in air. Resonance occurs when the external energy is supplied at the base frequency or a harmonic of the base frequency. The range of frequencies (fn) and the precision about a particular frequency (delta fn) that resonates into a structure depends in detail upon physical parameters of the structure. Examples of these parameters include the three dimensions, their uniformity, the distribution of the mass in the structure and the rigidity and the elasticity of the constituent materials of the structure. Generally, the smaller the delta fn the better the energy couples into the structure. Mosquitoes' wings have rigid scale like structures together with elastic capillary type membranes. The three dimensional shape of the wings of each species differ. The wing beats and the sound that it makes can identify the species. The sound and wing beats are so specific to a species that a male or female culex or anopheles gambiae mosquitoes can find each other in a cloud of mosquitoes.

To couple external energy into the wing and resonate with the wing, the energy is at a frequency that couples into the base frequencies of the wing and bends it with enough amplitude to break, for example a third order harmonic frequency can bend the wing into thirds. The advantage of using a resonate harmonic external frequency is that as the external signal couples into the wing, the harmonic builds and each pulse adds to the amplitude, forcing the wing to bend into the shape corresponding to the selected harmonic.

The present invention includes a broadcasting apparatus that emits a wave having the resonate frequency described above. The broadcasting apparatus may emit a specific ultrasonic sound frequency within a range of about 30 kHz to about 500 kHz. Alternatively, the broadcasting apparatus may emit modulated energy pulses, such as a specific light-heating carrier wavelength within a range of about 100 nm to about 500 nm with modulation wavelength of about 1 mm to about 10 mm. The emitted sound frequencies resonate and destroy the wings of the flying insects and thereby cause the insect to perish. The long wavelength of light (100 nm to 500 nm) is absorbed by the insects' wings and is modulated at very high frequencies so that the light results in oscillator heating of the wings (modulation wavelengths of 1 mm to 10 mm).

The broadcasting apparatus includes a tunable high-frequency signal generator circuit that generates a selected frequency or band of frequencies that is amplified by a broadband bandwidth amplifier. The broadband bandwidth amplifier provides the signal with amplitude control to the transducer, speaker and/or light source. The transducer and speaker generates and sends out a directional sound wave that induces a resonance in the insect's wing and thus breaks the wing causing the insect to fall. The present invention may further include a controller allowing users to control the amplitude level or frequency of the sound. The electrical power provides the electrical power to all the items mentioned above. The components of the present invention work together to send out a sound wave at a particular frequency or band of frequencies to break the wings of the target insects.

Referring to the FIGURES, the present invention includes a broadcasting apparatus 10. The broadcasting apparatus 10 includes an emitter 12 operable to emit a wave therefrom. The wave is at least one of a sound or one of a light. A power source 14 is operatively connected to the emitter 12 and provides power to the emitter 12. The wave emitted from the emitter 12 is capable of breaking a wing of an insect.

In certain embodiments, the present invention may further include a rotating base 16. The rotating base 16 is connected to and supports the emitter 12 in an upright position. A motor is operable to rotate the rotating base 16. When the motor is powered, the rotating base 16 rotates the emitter 12 up to about 360 degrees about a vertical axis. The wave is thereby emitted in multiple directions.

As mentioned above, the emitter 12 may emit a sound wave. In such embodiments, the present invention may further include a sound generator 22 and an amplifier 18 disposed within the broadcasting apparatus. The emitter 12 in such embodiments may be a speaker or a transducer. The speaker or transducer emits an ultrasonic sound having a frequency between about 30 kHz and 500 Khz. The frequency is capable of breaking the wings of insects, such as mosquitoes.

The broadcasting apparatus 10 may include preset frequency amounts. The preset frequency amounts may break the wings of different types of insects. Alternatively, the present invention may include a controller 20. The controller 20 may be a turn dial that is operable to adjust the frequency level of the ultrasonic sound. The turn dial may be rotated to change the frequency of the sound wave emitted from the speaker or transducer. Therefore, users may adjust the frequency depending on the type of insect that the user would like to target.

As mentioned above, the emitter 12 may be a light source. In such embodiments, the carrier wave is light of 10 nm to 500 nm wavelength. The light emitted from the light source may include a modulation wavelength of about 1 mm up to about 10 mm.

In certain embodiments, the broadcasting apparatus 10 may be capable of determining the destructive resonate frequency of the insect and then emitting the wave having the destructive resonate frequency of the insect. In such embodiments, the broadcasting apparatus includes a processor 24, a memory 26 and a detector 28. The memory 26 may contain software to direct the processor to perform steps. The memory 26 may further include data including a plurality of types of species of mosquito (identified by wing beats per unit of time or sound) each linked with a predetermined destructive resonate frequency value. The destructive resonate frequency value is a resonate frequency capable of destroying the wing of the type of species of mosquito. The detector 28 may include a sensitive sound receiver or may include a light source (laser or LED) and a receiver disposed within the broadcasting apparatus 10. Alternatively, the detector 28 may be remote from the broadcasting apparatus and may wirelessly transmit the reflected signal to the broadcasting apparatus. The light source and the receiver detects a change of light by way of reflection or interruption per unit of time caused by the wing beats of the mosquito to determine the wing beats per unit of time. The processor 24 matches the detected wing beats per unit of time with a wing beats per unit of time stored in the memory 26 to determine the type of species of mosquito detected. The matching process may include a fast Fourier transform of the detected wing beats to best match the data stored in the memory for precise determination of the insect to be killed. The processor 24 then directs the emitter 12 to emit the destructive resonate frequency value linked to the type of species of the mosquito to break the mosquito's wings, thereby killing the mosquito.

To determine the destructive resonant frequency values, mosquitoes of different species are exposed to measured outputs of resonate frequencies. The percentage of mosquitoes that are disabled at given distances from the sound or light source determines the destructive resonant frequency value for that species. In certain embodiments, relative humidity is measured and then used to modify the value of the destructive resonant frequency to adjust for the attenuation in humid air.

Alternatively, the destructive resonant frequency value may be calculated. An example of calculating the destructive resonate frequency of an insect may include the following. The anopheles mosquito's wing is about 16 mm long. A sound frequency of 5.3 mm long (one third the wing length) bends the wing into thirds. The frequency equals the speed in air divided by the wavelength. Using the speed of sound in air, sound transmits at 343,000 centimeters/second in standard conditions. Thereby the equation is 343,000/3, which equals 114,333 cycles per second (cps). Since the wing is not like rubber, conforming to the air pressure it experiences and is more rigid, the harmonic that bends the real wing into thirds is more complex. It varies inversely proportional to the third order resonance frequency. This frequency varies as the square root of the stiffness or rigidity of the wing divided by the mass of the material of the wing. Increasing the rigidity alone might increase the third resonance harmonic frequency but other material parameters play a compensating role.

The sound and light waves may be emitted over a large area. By killing certain insects, diseases may be contained or eliminated. The present invention may be emitted from helicopter, unmanned air vehicles, or other vehicles on a large scale in contaminated areas.

Disabling insect wings by broadcasting resonate frequency or a narrow band of frequencies has several advantages. Coupling the sound (pressure) waves to the wing's natural bending frequencies is an additive process. That is, every wave that hits the wing adds some energy to a particular bending wavelength, even those that hit it obliquely, so that the continuous repetition of these waves cause the wing to bend strongly and break the wings' supporting structure. Since the ultrasonic waves are much faster than the flying insects wing beats (typically much less than 1,000 beats per second) many sound pressure waves (approximately 100,000 per second) hit a moving wing before it moves appreciably. Further, the frequencies used to destroy the wings of insects are well above the human hearing range (limited to 20 kHz). These frequencies also depend upon the species of the flying insects so the apparatus can be set for a particular species or a family of flying insects, such as mosquitoes, and thereby avoid damaging other insects, such as bees.

It should be understood, of course, that the foregoing relates to exemplary embodiments of the invention and that modifications may be made without departing from the spirit and scope of the invention as set forth in the following claims.

What is claimed is:

1. A method of disabling flying insects comprising:
determining a resonate frequency of a wing of an insect capable of breaking the wing of the insect;
providing a broadcasting apparatus comprising an emitter operable to emit a wave comprising the resonate frequency, wherein the wave is at least one of a sound and a light; and
emitting the wave comprising the resonate frequency of the wing of the insect from the broadcasting apparatus.

2. The method of claim 1, wherein the broadcasting apparatus comprises a rotating base secured to the emitter and a motor operable to rotate the rotating base.

3. The method of claim 1, wherein the broadcasting apparatus further comprises an amplifier connected to the emitter.

4. The method of claim 1, wherein the emitter is a speaker and the wave is a sound.

5. The method of claim 4, wherein the sound is an ultrasonic sound comprising a frequency between about 30 kHz and 500 Khz.

6. The method of claim 5, wherein the broadcasting apparatus further comprises a controller operable to adjust a frequency level of the ultrasonic sound.

7. The method of claim 1, wherein the emitter is a light source and the wave is the light.

8. The method of claim 7, wherein the light emitted from the light source comprises a wavelength of about 1 mm up to about 10 mm.

9. The method of claim 1, wherein broadcasting apparatus further comprises a processor, a memory and a detector operable to detect a type of species of the insect, wherein the memory stores data comprising a plurality of types of species of insects each linked with a unique destructive resonate frequency, wherein the processor
determines the unique destructive resonate frequency of a detected insect using the detector and the data; and
directs the emitter to emit the unique destructive resonate frequency.

10. The method of claim 9, wherein the detector comprises a light source and a receiver operable to receive a reflected signal from the light source to determine a wing beats per unit of time of the insect, wherein the plurality of types of species of insects of the data are identified by wing beats per unit of time.
